(19) United States
(12) Patent Application Publication
(10) Pub. No.: US 2023/0014049 A1
(43) Pub. Date: Jan. 19, 2023

(54) MEASURING DEVICE AND METHOD FOR DETERMINING PROPERTIES OF A VISCOELASTIC MATERIAL

(71) Applicant: Bareiss Pruefgeraetebau GmbH, Oberdischingen (DE)

(72) Inventor: Oliver WIRTH, Ehingen (DE)

(73) Assignee: Bareiss Pruefgeraetebau GmbH, Oberdischingen (DE)

(21) Appl. No.: 17/864,668

(22) Filed: Jul. 14, 2022

(30) Foreign Application Priority Data
Jul. 16, 2021 (DE) 10 2021 118 415.0

(51) Int. Cl. G01N 11/14

(52) U.S. Cl. CPC G01N 11/142

(57) ABSTRACT

A measuring device, in particular a measuring device of the type of a rheometer, and a method determines properties of a viscoelastic material, which has been introduced or can be introduced into a temperature-regulated sample space between an upper chamber half provided with a sensor and a lower chamber half that can be rotated relative to the upper chamber half. The lower chamber half is driven or can be driven by a motor and is connected with at least one slip ring (that creates an electric path into the interior of the sample space on the lower chamber half, so that the lower chamber half can be rotated, with reference to the upper chamber half, about an angle of rotation over 360°.

### CROSS REFERENCE TO RELATED APPLICATIONS

Applicant claims priority under 35 U.S.C. § 119 of German Application No. 10 2021 118 415.0 filed Jul. 16, 2021, the disclosure of which is incorporated by reference.

### BACKGROUND OF THE INVENTION

### 1. Field of the Invention

The invention relates to a measuring device, in particular a measuring device of the type of a rheometer, and to a method for determining properties of a viscoelastic material.

### 2. Description of the Related Art

Rheometers having a closed chamber system are known from the general state of the art. Such measuring devices are consequently also frequently referred to, according to English language usage, as an RPA measuring device (RPA=rubber process analyzer). For measuring, rubber mixtures are introduced into a chamber between two chamber walls that oscillate against one another. Typically, in this regard, deflections in the range of 0.001° to 360° in both directions of rotation are achieved. The frequency of these rotational movements can vary over a great range of 0.001 Hz to 100 Hz. Likewise known is to vary the torque in the range of several 100 μNm to approximately 25 Nm. The temperature of the rubber mixture can reach as much as approximately 230° C. during the measurement.

With such oscillating rheometers, the possibility arises of carrying out all common measurements during the rubber mixture development. Aside from relaxation or multi-wave measurement, as well as isothermal or anisothermal measurement and an amplitude or frequency pass, what is called the jump test or ramp test also belongs to the known repertoire of common measurements.

Thus, an apparatus for measuring the viscoelasticity of natural rubber or plastic materials is already known from DE 1 648 526 A1. This apparatus is configured with an upper and a lower frame, a plurality of guide rods that stand upright in the lower frame and support the upper frame, an upper shear plate that can be moved vertically along at least one pair of the guide rods, a support plate that is uniform with the upper shear plate and provided with bearings, an upper plate that can perform vertical movements uniformly with the support plate and is attached to a shaft mounted in the bearing and can be rotated in the bearing, a lower plate that is arranged on the lower frame so as to pivot, a device for pressing the upper plate against the lower plate, a device for bringing about a back-and-forth angle displacement of the lower plate relative to the upper plate and having a device for individual heating of the upper and lower plate.

From DE 10 2010 050 973 A1, a rheometer or viscosimeter is known, having a first measuring part and a second measuring part between which a sample space for holding a material sample is formed, and having a drive apparatus by means of which the second measuring part rotates and/or oscillates. The drive movement of the drive apparatus can be transferred to the second measuring part by way of a transmission element, wherein the drive device is arranged on the side of the first measuring part that faces away from the second measuring part, and the transmission element penetrates the first measuring part.

In the case of previously known measuring devices, the problem often occurs that the viscosities measured using them, as a function of time, do not reach a plateau value actually required for such measurements, in spite of a maximum deflection of 360°, so that the actual material properties can be only estimated.

### SUMMARY OF THE INVENTION

Proceeding from this state of the art, the object now arises of providing a measuring device and a method for measuring properties of a viscoelastic material, which overcome the problems mentioned above and have improved properties.

These and other objects are accomplished by means of the characteristics of the invention. Further advantageous embodiments of the invention are discussed below. These embodiments can be combined with one another in a technologically practical manner. The specification, in particular in connection with the drawing, additionally characterizes and specifies the invention.

According to the invention, a measuring device for determining the properties of a viscoelastic material is provided, in particular of the type of a rheometer, which is introduced or can be introduced, in a temperature-regulated sample space in its interior, between an upper chamber half, provided with a sensor, and a lower chamber half that can be rotated relative to the upper chamber half, The lower chamber half is driven or can be driven by a motor, wherein the lower chamber half is connected with at least one slip ring that creates an electrical path into the interior of the sample space on the lower chamber half, so that the lower chamber half can be rotated, with reference to the upper chamber half, about an angle of rotation over 360°.

In the case of the measuring device according to the invention, the interior of the sample space is temperature-regulated, which is brought about by way of an electrically driven heat source that is arranged both on the upper chamber half and on the lower chamber half. In this way, a closed, sealed chamber system composed of upper chamber half and lower chamber half can be made available, without having to fall back, in this regard, on the heating method already known from the state of the art, by means of an oven arranged around the chamber. For this reason at least one electric path is required to regulate the temperature in the sample space, so as to be able to supply the heat source with electric energy.

The one electric path can be used as a current path for supplying energy, together with the housing mass. Temperature measurement would also be possible in a contact-free manner. In practice, however, multiple electric paths will be configured, which are used both for a connection with a temperature sensor and for supplying energy. In the case of a wired, system, however, the deflection of the two chamber halves relative to one another is limited.

This limitation is where the invention takes its start. In that the feed of electric energy by way of the electric path, into the interior of the sample space on the lower chamber half, takes place by way of a slip ring, it is possible to rotate the lower chamber half by more than 360° without having to take into consideration cables that wind up. In the case of what is called the jump test, in particular, this method of procedure proves to be advantageous, because now there is no longer any limitation with regard to the deflection.

In the jump test, a chamber half is greatly deflected, using the motor drive, during a defined time period, and the resulting torque is measured on the other chamber half. The jump response, in other words the torque, should become a constant value, so as to be able to create a meaningful measurement of the viscosity. If a plateau value had not yet been reached, the deflection was insufficient. Now, by means of the slip ring, a deflection of greater than 360° is possible, so as to cancel out the limitation with regard to deflection as described above.

According to an embodiment of the measuring device according to the invention, the lower chamber half can be rotated with reference to the upper chamber half about any desired angle of rotation and any desired number of rotations.

As has already been mentioned, there is no longer any limitation with regard to the maximally possible deflections of the lower chamber half with reference to the upper chamber half. Accordingly, it is possible to achieve any desired angle of rotation and any desired number of rotations. In practice, the deflection is selected in such a manner that a plateau value of the resulting torque occurs on the upper chamber half.

According to a further embodiment of the measuring device according to the invention, multiple slip rings are provided, each of which creates an electric path into the interior of the sample space.

In and of itself, it would be sufficient to create only one electric path into the interior of the sample space, so as to supply the heat source arranged there on the lower chamber half with electric energy. For example, the circuit to the heat source could be closed by way of the housing mass. In a preferred variant of the invention, however, multiple slip rings will be provided, so as to transfer not only the supply of electric energy but also, for example, data of a temperature sensor that can be arranged on the lower chamber half.

According to a further embodiment of the measuring device according to the invention, the slip ring or slip rings make possible at least the electric path for controlling the temperature regulation in the interior of the sample space.

The closed chamber system of the measuring device according to the invention is controlled by way of the electric path. This feature represents the minimum embodiment, so to speak, wherein usually further measurement variables or further signal paths can be made available so as to be able to control the conditions in the interior of the sample space.

According to the invention, the slip ring or rings can be arranged between the lower chamber half and a motor, on a drive shaft of the motor. Alternatively, however, it is also possible to arrange the slip ring or rings on a rotational axle of the lower chamber half.

Typically, the slip ring or rings will be arranged on a drive shaft of the motor that deflects the lower chamber half. It would also be possible, however, to deflect the lower chamber half by way of a gear crown arranged along the outer circumference. The lower chamber half is then held on a rotational axle at its point of rotation, on which axle the slip ring can be arranged.

The object of the invention is also accomplished by means of a method for determining properties of a viscoelastic material, in particular by means of a rheometer. In this method, the viscoelastic material is introduced into a temperature-regulated sample space between an upper chamber half provided with a torque sensor or a combined torque/force sensor, and a lower chamber half that can be rotated relative to the upper chamber half, the lower chamber half is driven by a motor. The lower chamber half is connected with at least one slip ring that creates an electric path into the interior of the sample space, and the lower chamber half can be rotated, with reference to the upper chamber half, by an angle of rotation over 360°, so as to determine a torque at the upper chamber half during rotation of the lower chamber half by way of the force sensor.

As has already been mentioned above, the method according to the invention is aimed at no longer having any kind of limitation with regard to rotation of the lower chamber half.

According to an embodiment of the method according to the invention, the lower chamber half can be rotated about any desired angle of rotation with reference to the upper chamber half.

In this regard, any desired angles of rotation and any desired number of rotations can be achieved.

According to a further embodiment of the method according to the invention, during the measurement the lower chamber half can be rotated with reference to the upper chamber half any desired number of rotations.

In practice, it is often sufficient to make available deflections of up to ten rotations.

According to a further embodiment of the method according to the invention, the lower chamber half is rotated during the measurement, with reference to the upper chamber half, until a constant value of the viscosity occurs, derived from the torque values measured as a function of time.

In the case of the method according to the invention, the number of rotations, i.e. the deflection of the lower chamber half can be increased until a plateau value of the measured torque values occurs. Accordingly, it is possible to carry out viscosity measurements for different viscoelastic materials and over a great temperature range or pressure range.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein components that are the same or functionally equivalent are provided with the same reference symbols,

FIG. 1 shows a measuring device according to the invention, in a perspective side view;

FIG. 2 shows a detail of the measuring device according to the invention, from FIG. 1, in a sectional view;

FIG. 3 shows a further detail of the measuring device according to the invention, from FIG. 1, in a sectional view;

FIG. 4 shows a measurement diagram when using the method according to the invention; and

FIG. 5 shows a further measurement diagram when using the method according to the invention.

### DETAILED DESCRIPTION OF PREFERRED EMBODIMENTS

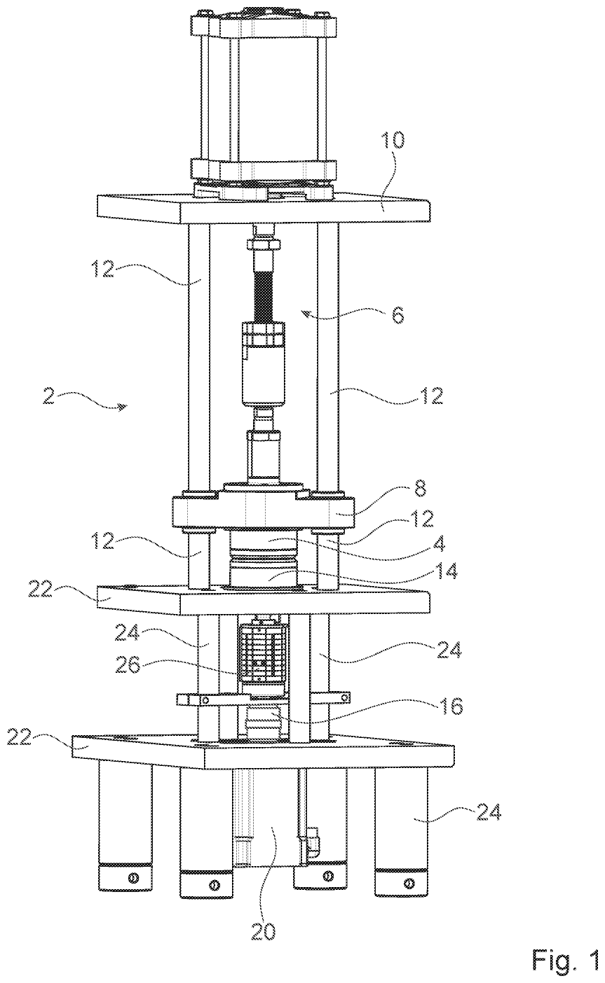

In FIG. 1, an embodiment of a measuring device 2 according to the invention is shown in a perspective side view. The representation according to FIG. 1 should be understood as being merely an example, wherein only those components of the measuring device 2 are shown that are relevant for explaining the invention. The measuring device 2 is of the type of a rheometer and comprises an upper chamber half 4, which is fastened to a traverse 8 in a freely movable manner, by way of a closure system 6, using a closing cylinder.

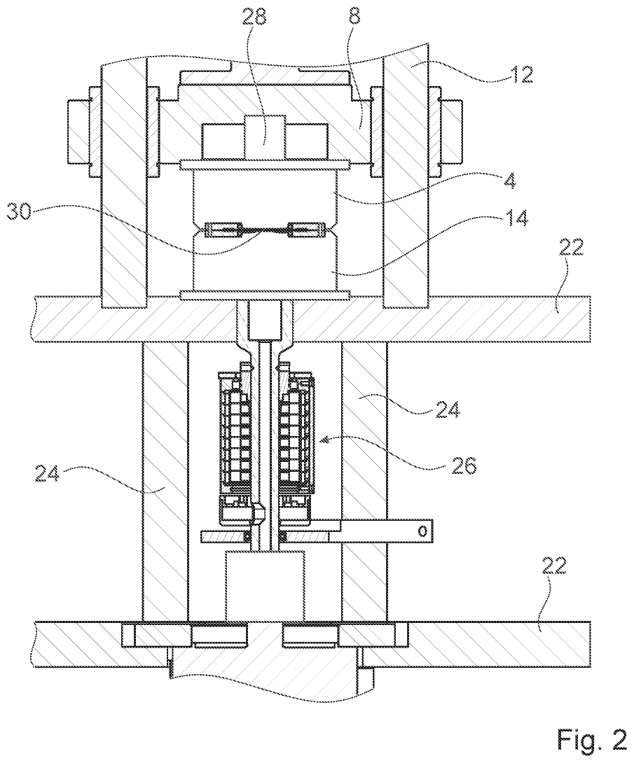

Furthermore, the upper chamber half 4 is connected with a sensor 28 shown in FIG. 2 in the interior of the housing, for determining the torque or a force and the torque. It is true that the upper chamber half 4 is movable with reference to the mounting plate 10 and the longitudinal struts 12, but it is held in its position by the traverse 8. Opposite the upper chamber half 4, a lower chamber half 14 is arranged, which is connected with an electric motor 20 by way of a drive shaft 16.

The lower chamber half 14 can be rotated with reference to the further mounting plates 22 and/or the further longitudinal struts 24. On the drive shaft 16, multiple slip rings 26 are arranged, which each create an electric path to the lower chamber half 14. The designation as an upper chamber half 4 or lower chamber half 14, in each instance, refers to their position relative to one another, as well as to the usual arrangement in the case of a rheometer 2, but not to an absolute position in space. Of course, the two chamber halves can also be arranged differently.

The upper chamber half 4 and the lower chamber half 14 together form a measuring chamber having a cavity, called sample space in the following, in its interior. A viscoelastic material is introduced into the sample space, in order to determine its material properties. By means of deflection of the lower chamber half 14, using the electric motor 20, a torque as a function of time can be determined by way of the sensor 28, as a jump response, so that a determination of the viscosity of the introduced material is possible.

During the measurement, the measuring device 2 is kept at a fixed temperature by means of a regulator. The connections for electric lines required for the lower chamber half 14 are made available by means of the slip ring 26. The slip ring 26 allows rotation of the lower chamber half 14, without having to take into consideration cables that wind up. It is therefore possible to select the deflection of the lower chamber half 14 without the restrictions known from the state of the art.

In FIG. 2, the structure of the measuring device 2 is shown once again in a more detailed sectional representation. One can see that the lower chamber half 14 and the upper chamber half 4 together form a closed chamber system. Likewise, the sample space 30 can be seen, as can the sensor 28.

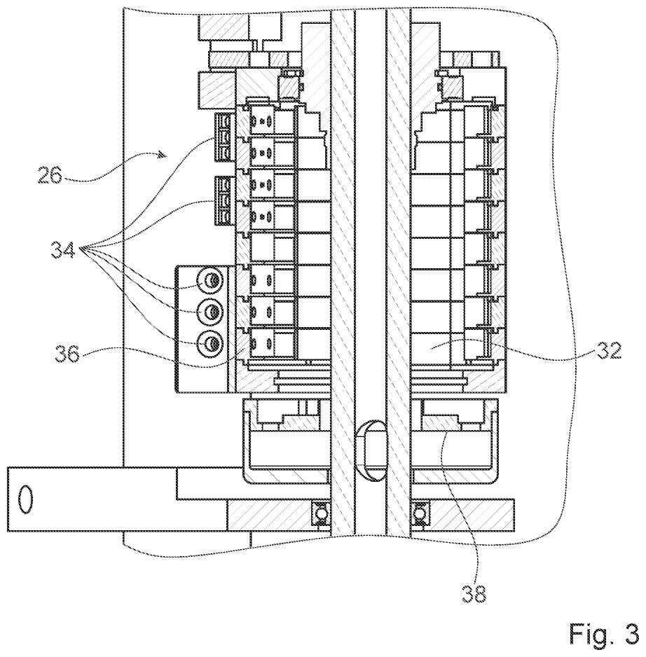

In FIG. 3, a further detail representation of the measuring device 2 is shown in the region of the slip ring 26. For transmission of multiple electric signals, multiple conductor rings 32 can be seen here, which are mechanically connected with the rotating lower chamber half 14. An electric connection with the stationary connectors 34, which do not move relative to the other components, is produced in a manner usual in the field, by way of a slip or brush contact 36. Corresponding rotating connectors 38, which are arranged in the region of a top side in FIG. 3, can create a connection to the sample space 30 in the region of the lower chamber half 14, by way of one or more cables.

In this way, it is possible to increase the size of the deflection of the lower chamber half 14, in almost any desired manner, and, in particular, to expand it to include deflections of greater than 360°.

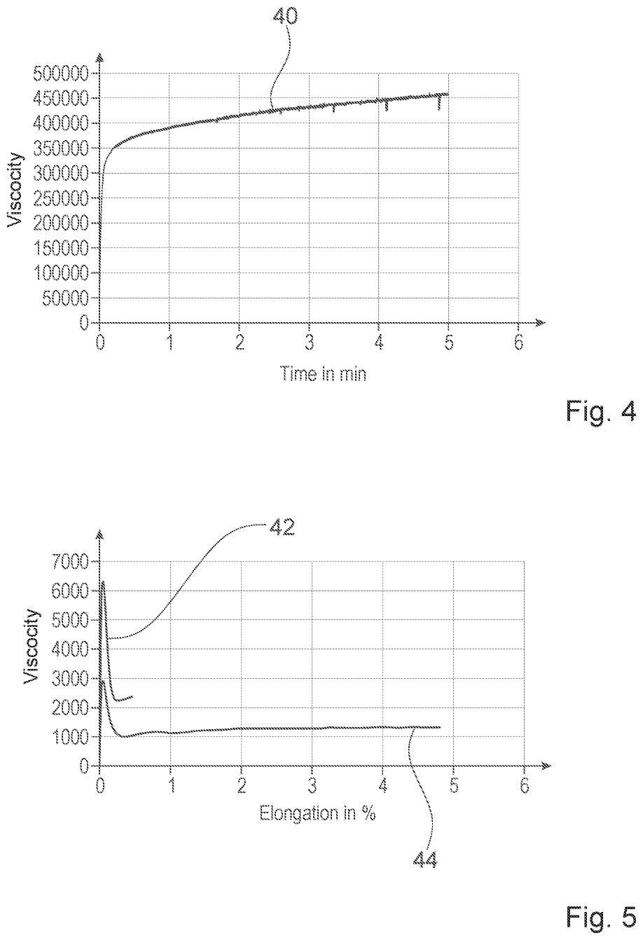

The need for an increase in the deflection of the lower chamber half 14 is explained using the example of the measurement diagram of FIG. 4. FIG. 4 shows the typical progression of the viscosity 40 as a function of time. In this regard, the maximum deflection is limited to 360°. One can see that the viscosity does not achieve a constant value, which would be necessary for a viscosity determination by means of the jump response.

In comparison to FIG. 4, two measurements (viscosity progressions) 42 and 44 are shown in FIG. 5, wherein the measurement with the reference number 42 is restricted to 360°, and for the measurement with the reference number 44, ten rotations, i.e. a deflection of 3600° was selected. It can be seen that a constant progression occurs for the viscosity only after approximately 5 rotations. This plateau value corresponds to the actual viscosity of the material being investigated. In the case of the progression according to the measurement having the reference number 42, this value cannot be determined or would have to be estimated.

The characteristics indicated above and in the claims, as well as those that can be derived from the figures, can be advantageously implemented both individually and in various combinations. The invention is not restricted to the exemplary embodiments described, but rather can be modified in many ways, within the scope of the ability of a person skilled in the art.

Although only a few embodiments of the present invention have been shown and described, it is to be understood that many changes and modifications may be made thereunto without departing from the spirit and scope of the invention.

What is claimed is:

1. A measuring device for determining properties of a viscoelastic material comprising:
(a) an upper chamber half;
(b) a sensor provided in the upper chamber half;
(c) a lower chamber half rotatable relative to the upper chamber half;
(d) a temperature-regulated sample space arranged between the upper chamber half and the lower chamber half for receipt of the viscoelastic material;
(e) a motor for driving the lower chamber half; and
(f) at least one slip ring connected with the lower chamber half;
wherein the at least one slip ring creates an electric path into an interior of the sample space so that the lower chamber half can be rotated, with reference to the upper chamber half, about an angle of rotation over 360°.

2. The measuring device according to claim 1, wherein the lower chamber half can be rotated, with reference to the upper chamber half, any selected number of rotations and about any selected angle of rotation.

3. The measuring device according to claim 1, wherein a plurality of slip rings are provided, wherein each slip ring of the plurality of slip rings creates an electric path into the interior of the sample space.

4. The measuring device according to claim 1, wherein the at least one slip ring creates an electric path for regulating temperature in the interior of the sample space.

5. The measuring device according to claim 1, wherein the at least one slip ring is arranged on a drive shaft of the motor between the lower chamber half and the motor.

6. The measuring device according to claim 1, wherein the at least one slip ring is arranged on a rotational axle of the lower chamber half.

7. The measuring device according to claim 1, wherein the sensor (is a torque sensor or a combined torque/force sensor.

8. A method for determining properties of a viscoelastic material comprising:
(a) introducing the viscoelastic material into a temperature-regulated sample space between an upper chamber half provided with a torque sensor or a combined torque/force sensor and a lower chamber half that is rotatable via a motor relative to the upper chamber half;
(b) creating an electric path into an interior of the sample space by connecting the lower chamber half with at least one slip ring; and
(c) rotating the lower chamber half, with reference to the upper chamber half, about an angle of rotation over 360°, so as to determine using the sensor at least one torque on the upper chamber half during the rotation of the lower chamber half.

9. The method according to claim 8, wherein the lower chamber half is rotatable, with reference to the upper chamber half, any selected number of rotations and about any selected angle of rotation.

10. The method according to claim 9, wherein the lower chamber half, with reference to the upper chamber half, is rotated, during the measurement, until a constant value of the torque occurs, derived from torque values measured as a function of time.
